(19) United States
(12) Patent Application Publication
(10) Pub. No.: US 2002/0194097 A1
(43) Pub. Date: Dec. 19, 2002

(54) Method and system for two-way communication between asset managers and asset custodians

(76) Inventor: James T. Reitz, Babylon, NY (US)

Correspondence Address: BRYAN CAVE LLP, 245 Park Avenue, New York, NY, 10167-0034, US

(21) Appl. No.: 09/850,498

(22) Filed: May 7, 2001

(51) Int. Cl. G06F 17/60; G06F 9/46

(52) U.S. Cl. 705/36; 705/35; 709/318

(57) ABSTRACT

A two way messaging interface for communication between asset managers and asset custodians is disclosed. The interface transmits and receives SWIFT messages which are customized for event-specific messages to be transmitted within the SWIFT format. The messages are generally encoded in the SWIFT MT598 format and are passed along to recipients within the SWIFT data network. The messages may trigger routines for handling custodial transactions for the asset manager and the asset custodian.

### FIELD OF INVENTION

The present invention relates to the field of communication across data networks, and more particularly, to a two-way communication interface across a data network between an asset manager and an asset custodian.

### BACKGROUND OF THE INVENTION

Asset managers typically direct investment in investment assets for the benefit of shareholders of a fund and pension and profit sharing plans of investors. Asset managers generally make investment decisions for the benefit of shareholders, plan participants, or other beneficiaries and typically deal in securities. Asset custodians hold assets for the asset managers and track ownership and record corporate changes in the assets, sometimes as a trustee. For business integrity and other reasons, asset custodians typically track ownership and record changes for the assets in the asset manager's portfolio. Asset custodians should ideally be in constant communication with the asset manager so that changes in the portfolio are properly reflected in the custody records of the asset fund or plan. Therefore, the asset manager and the asset custodian are typically interconnected to each other through a data network for exchanging message packets.

The data network may be a propietary data network, an open data network such as the Internet, or a shared public data network. The message packets exchanged between the asset manager and the asset custodian are typically encoded in the format laid out by the Society for the Worldwide Interbank Funds Telecommunications (“SWIFT”). The SWIFT message format is commonly used for interbank fund transfers and related messages exchanged over the data network.

The SWIFT data network provides a technology based communication service across worldwide financial markets. More than 6500 financial institutions in 178 countries connect to the SWIFT network. Although SWIFT was initially developed only for facilitating interbank fund transfers, SWIFT has now been modified to allow securities transactions between asset managers and asset custodians and asset brokers.

Asset custodians typically handle custodial transactions concerning the asset for the asset manager. For instance, if the asset were equities, the asset custodian is responsible for registering the stock under the custodian's name, and keeping it in trust for the asset manager's customers. The asset custodian is additionally responsible for recording corporate events regarding the asset (such as mergers, stock splits, etc. for securities), keeping track of proxy and tax services, and providing asset valuations for the asset manager. The asset custodian is typically a bank, a broker, or some other financial intermediary.

Today, more than ever, investors have a myriad of funds and plans to choose from and investors are seeking greater returns. Many funds and plans have looked to foreign and emerging markets and consequently many families of funds and plans are operating 24 hours a day in different regions of the world. Additionally, with the competition for investors' dollars, funds are seeking to streamline their costs and improve the efficiency by automating many aspects of trade execution. However, there is a level of manual oversight that is required when asset managers and asset custodians are located in different regions of the world. Consider the example of an asset manager located in London and an asset custodian located in New York. The business day for the asset manager may begin at 8 AM Greenwich Mean Time while the business day for the asset custodian may begin at 8 AM Eastern Standard Time. The five hour time zone difference between the business days means that updating of the package of settled asset positions and other custodial matters require manual oversight and costly labor. If the asset manager and asset custodians are located at different parts of the world or in different time zones, the asset manager and asset custodian, even if they exchange electronic messages in compliance with the SWIFT format, must employ some type of manual oversight. The task is made even more complex if the asset manager resides in one region of the world and manages assets that are traded in another region of the world. With the consolidation of asset management services and the globalization of the asset management business it is more important to streamline and automate the process as much as possible.

Therefore, there is a need for a two-way communication interface system and method between an asset manager and an asset custodian which tracks the regular business day and business cycle of the asset manager and asset custodian so that automated processes can be executed for many of the functions of the asset manager and asset custodian.

### SUMMARY OF THE INVENTION

In accordance with the invention, a method and system for two-way communication between asset managers and asset custodians is disclosed. In one aspect the invention concerns a messaging interface system between an asset manager and an asset custodian, said asset manager and said asset custodian capable of transmitting and receiving messages, said system comprising:

an asset manager interface coupled to said asset manager for generating and transmitting event-specific messages;

an asset custodian interface coupled to said asset custodian for receiving said event-specific messages, said asset custodian interface initiating automated processes upon receipt of said event-specific messages; and

a data network coupled therebetween said asset manager interface and said asset custodian interface.

In another aspect, the invention concerns a system for transmitting and receiving electronic messages for trading securities among an asset manager and an asset custodian, said system comprising:

a database for storing custody information concerning said securities; and

an interface coupled to said database for transmitting event-specific messages upon occurrence of predetermined events.

### BRIEF DESCRIPTION OF THE FIGURES

A more complete understanding of the present invention may be obtained by considering the following description in conjunction with the drawings in which:

FIG. 1 is a schematic diagram of a data network connection between an asset manager and an asset custodian in accordance with the principles of the present invention;

FIG. 2 is a schematic daigram of an exemplary SWIFT category 5 message packet; and

FIGS. 3 is a flowchart illustrating the detailed steps of the message flow in accordance with the principles of the present invention.

### DETAILED DESCRIPTION

An asset manager typically invests and trades in assets managed for the benefit of fund shareholders and plan participants. Assets typically invested include stocks, bonds, money markets, currency, gold, silver, oil, gas and other precious metals and minerals and combinations of those assets and derivatives of those underlying assets such as options, swaps, and futures. The asset manager trades the various assets or combinations of the assets during the trading day and transmits results of the asset trades to the asset custodian.

An asset custodian is typically appointed by the asset manager as the legal custodian of the asset manager's assets. Legal custody gives the custodian the ability to make disbursements from the assets of the fund. Generally, an independent custodian is either a trust department of a bank or clearing firm, an independent trust company, or a licensed attorney. The custodian oversees all fund disbursements and issues checks upon the request of the fund manager or investors in the fund. The asset custodian records the results of the asset trades. For example, the asset custodian records the ownership changes on the records of the assets that were traded during the business day. Typically, the asset custodian records the ownership and reconciles trades at the end of the day for the benefit of the asset manager. The reconciliation may be performed between the asset custodian and the asset manager at the time of the transaction or at the end of the day. The end of the business day reconciliation's are settlements of trades that were made during the business day so that the asset with the asset custodians.

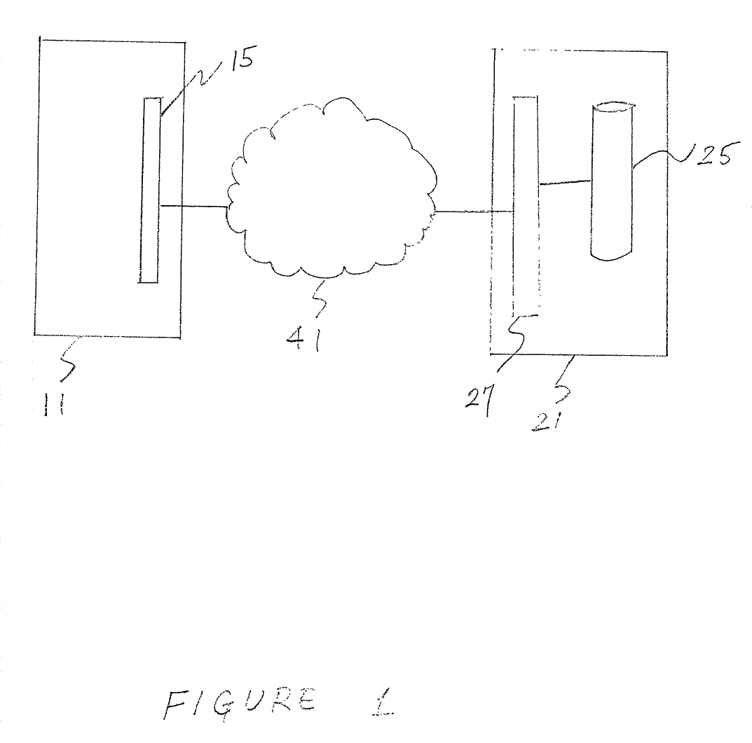

Referring to FIG. 1, there is shown a system in accordance with the principles of the present invention. An asset manager 11 includes an interface 15 for coupling to the open data network 41. The asset custodian 21 includes a database 25 for storing and retrieving asset custody information and interface 27 for coupling to the open data network 41. In one embodiment of the present invention, the data network 41 is a SWIFT data network. However, it will be understood by one skilled in the art that the present invention may also be implemented over a virtual private network interconnecting a single asset custodian and a single asset manager. In an alternative embodiment, the data network may be a public data network such as the Internet. It should be noted that a single asset custodian may handle a plurality of different accounts (or finds) from asset manager 11. It will further be understood that there may be a plurality of asset custodians and asset managers which are interconnected by the data network 41.

The database 25 is a custody information database storing records pertaining to custody information of the assets. The database may be implemented by any suitable database means such as DB2, SQL or Sybase. Records within the database correspond to assets and typically contain asset ownership information, asset transaction histories, and asset corporate actions.

In one embodiment, messages over the data network between the asset manager and the asset custodian are encoded in the SWIFT format. SWIFT is governed by a United Nations sanctioned International Standards Body (“ISO”) for the creation and maintenance of financial messaging standards. SWIFT is implemented over an X.25 protocol packet switch network capable of delivering millions of messages a day between financial institutions such as banks, trading institutions, broker/dealers, and fund managers. SWIFT oversees user to user service comprising messages in certain fixed formats laid out by the standards body. However, it will be apparent to one skilled in the art that the present invention may be implemented using any fixed format of data communication between an asset manager and an asset custodian. The exemplary embodiment is illustrated herein utilizing ISO 7775 (also known as SWIFT 97). However, applicability of the invention to other SWIFT formats (such as ISO 15022 (also known as SWIFT 98)) and other data formats will be apparent.

The interface 15 and 27 of the present invention are functional entry and exit points to the data network. The interfaces conventionally provide sequence number checking and message validation of any outgoing or incoming SWIFT messages, including acknowledgments of received messages. In a preferred embodiment, the interfaces of the present invention provide automated routing of SWIFT messages which signal different phases of the business day for the asset manager.

It is instructive to note the formatting of the SWIFT messages over the data network. SWIFT messages are categorized into ten categories dependent on the type of financial transaction. Inside each category are standardized messages for routine transactions. Table 1 below lists the categories and the type of transactions the SWIFT messages are intended to carry. It should be noted that XX signifies a two digit number.

TABLE 1

| | |
|---|---|
| MT0XX | System Messages |
| MT1XX | Customer Payments |
| MT2XX | Financial Institution Transfers |
| MT3XX | FX, Money Market and Derivatives |
| MT4XX | Collections and Cash Letters |
| MT5XX | Securities Markets |
| MT6XX | Precious Metals and Syndications |
| MT7XX | Documentary Credits and Guarantees |
| MT8XX | Travellers Cheques |
| MT9XX | Cash Management and Customer Status |

The category 5 messages (MT5XX) are the most relevant for the asset manager and the asset custodian. Within the category 5 SWIFT messages are standard message types as shown in Table 2 below.

TABLE 2
General Messages

| | |
|---|---|
| MT590 | Advice of Charges, Interest and Other |
| | Adjustments |
| MT591 | Request for Payment of Charges, Interest and |
| | Other Expenses |
| MT592 | Request for Cancellation |
| MT595 | Queries |
| MT596 | Answers |
| MT598 | Proprietary Message |
| MT599 | Free Format Message |

Trading

| | |
|---|---|
| MT500 | Order to Buy |
| MT501 | Order to Sell |
| MT502 | Order to Buy or Sell |
| MT510 | Confirmation of Purchase or Sale |
| MT512 | Securities Trade Confirmation |
| MT513 | Client Advice of Execution |
| MT514 | Trade Allocation Instruction |
| MT515 | Client Confirmation of Purchase or Sale |
| MT517 | Trade Confirmation Affirmation |
| MT518 | Market Side Securities Trade Confirmation |
| MT519 | Advice of Execution |

Settlement

| | |
|---|---|
| MT520 | Receive Free |
| MT521 | Receive Against Payment |
| MT522 | Deliver Free |
| MT523 | Deliver Against Payment |
| MT530 | Confirmation of Receipt Free |
| MT531 | Confirmation of Receipt Against Payment |
| MT532 | Confirmation of Delivery Free |
| MT533 | Confirmation of Delivery Against Payment |
| MT534 | Notice of Settlement Problem |
| MT539 | Advice of Receipt/Delivery |
| MT580 | Instruction to International Clearers |
| MT583 | Depot Management Advice |

Securities Lending and Borrowing

| | |
|---|---|
| MT516 | Securities Loan Confirmation |
| MT526 | General Securities Lending/Borrowing |
| MT581 | Collateral Adjustment Message |
| MT582 | Reimbursement Claim or Advice |

Corporate Actions

| | |
|---|---|
| MT550 | Notice of Rights |
| MT551 | Notice of Event |
| MT552 | Notice of Offering or Privilege |
| MT553 | Instruction to a Custodian |
| MT560 | Notice of Bond or Shareholders' Meeting |
| MT561 | Proxy or Authorization and Instructions to |
| | Vote |
| MT562 | Corporate Action Status Report |
| MT563 | Corporate Action Confirmation |

Capital and Income

| | |
|---|---|
| MT554 | Advice of Money Income |
| MT555 | Advice of Income in the form of Securities |
| MT556 | Advice of Redemption |
| MT557 | Advice of Securities Proceeds |
| MT559 | Paying Agent's Claim |

Inter-depository and Clearing Instructions

| | |
|---|---|
| MT525 | Inter-depository/Clearing System |
| | Receive/Deliver Transaction |
| MT585 | Inter-depository/Clearing System |
| | Administration |

Statements

| | |
|---|---|
| MT570 | Request for Statement |
| MT571 | Statement of Holdings |
| MT572 | Statement of Transactions |
| MT573 | Statement of Pending Transactions |
| MT574 | Statement of Open Orders |
| MT576 | Statement of Open Orders |
| MT577 | Statement of Numbers |
| MT579 | Certificate Numbers |

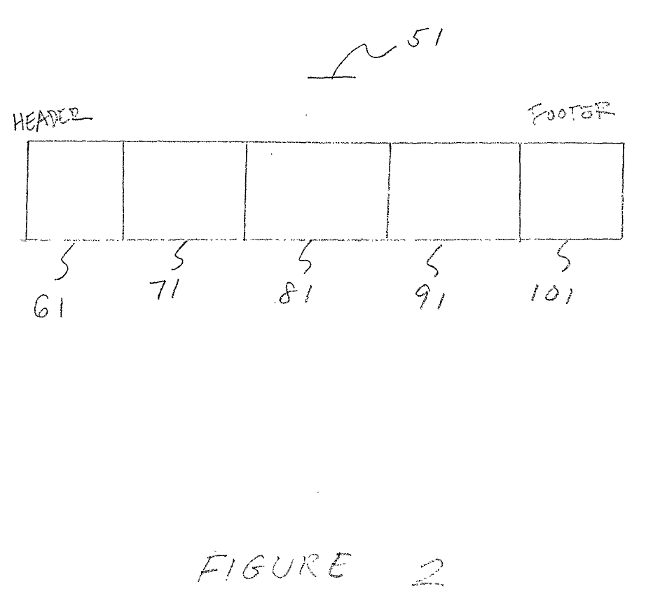

Referring to FIG. 2, there is shown a schematic structure of an exemplary SWIFT category 5 message packet 51. A basic header block 61 consists of a fixed length field with no field separators. The basic header block 61 consists of a block ID, application ID, service ID, and terminal address. An application header block 71 follows the header block 61 and includes formatting to differentiate from whether the message packet 51 is being transmitted from the SWIFT financial network or is being transmitted to the SWIFT financial network. The application header block includes the message type and the message priority for proper handling at the recipient end. A user header block 81 follows the application header block 71 and contains sub blocks or fields delimited by field tags. A text block 91 follows the user header block 81 and comprises the main body of the message packet. The text block is where the MTXXX message is specified. The body of the SWIFT message is contained within the text block. A trailer block contains authentication code to ensure that the message packet is received at the destination with the correct body of the message. A checksum routine and an authentication code with a private key is decoded from the trailer block.

As stated, the text block 91 contains the actual body of the SWIFT message. The other blocks are used to ensure routing, addressing and authentication. For most messages, the SWIFT messaging system strips out headers and footers so that only the text block 91 is available for the user. In the case of standardized SWIFT messages, there are fixed formats for most of the messages so that standardized automated transactions can occur between the communicating parties. In the case, of nonstandardized messages, SWIFT provides a proprietary message format, MT598, which allows for customized messages. Combined with the standardized messages that SWIFT already incorporates, the customized messages of the present invention will aid in automating the communication between the asset manager and the asset custodian.

A series of customized messages signaling routine business day events are disclosed herein. It is contemplated that the customized messages transmitted between the interfaces of the present invention can be automatically generated and processed by the interface upon the occurrence of certain events such as the closing of the business day. In a preferred embodiment, the customized messages are encoded in the MT598 format and transmitted automatically as certain events occur.

The asset manager generates a SWIFT MT598 message to indicate that it has closed its business for the day in trading the assets. A Close of Business (“COB”) done trading message is generated and transmitted from the asset manager to the asset custodian. The message is to inform the asset custodian that the trading day of the asset manager is over for a certain account. The message also signals the asset custodian that the asset manager is ready to receive the package of positions, settled transactions, and pending transactions for reconciling with the asset manager.

The COB done trading message is also used as a benchmark to provide a measurement of the service level for the asset custodian. For instance, the message provides a point in time so that the asset manager can track transactions posted to the asset custodian and which must be accounted for in the end of the business day package. A measurement of service level can be tracked by the asset manager sensing the time delay in settling transactions posted during a business day.

The asset custodian, upon receipt of the COB done trading message, automatically suspends the account for which the message was transmitted. The suspension occurs for all trading activity except for all of the trading activity completed before the COB done trading message. The suspension does not apply to the trading messages received prior to the COB done trading message for the account. The account is automatically suspended in the custody information database.

The asset custodian subsequently transmits another customized message, the Regional COB message. The Regional COB message inform the asset manager that all acknowledgments and responses to the transactions have been completed. The message can also act as a service level indicator so that the time between this message being transmitted and the time the Close of Business package is transmitted can be measured.

The asset custodian subsequently transmits an Account level COB message. The asset manager transmits a COB reconciliation complete message by account and region which informs the asset custodian that the asset manager's reconciliation of the Close of Business package is complete and that the asset manager is ready to resume sending intraday trade instruction messages.

When the COB reconciliation complete message is received, the suspended account is released and all acknowledgment transactions that have been held in the queue while the account is suspended are delivered. Subsequently, the account level COB reconciliation message is updated and marked completed. At the time of the region level COB reconciliation message being received, the message is updated and marked as completed.

The asset custodian may, at different times of the business day, transmit a processing systems closed message to inform the asset managers that the asset custodian has closed its securities and cash processing systems for batch processing and that any instructions that have been transmitted by the asset manager but that have not been acknowledged, will not be included in the following day's COB package.

The rolldate message is classified by region and sent by the asset custodian to inform the asset manager that all post-COB and pre-Start of Business (“SOB”) activity (for e.g., security number changes, redemptions, and maturities, and mandatory corporate action transactions) have been transmitted to the asset manager and that the custodian is rolling forward the date to the next business date for SOB processing.

The rolldate message is received by the custody information database and all accounts for which an account level COB message has been received are suspended. A message is transmitted to the message interface. The message contains an end of day message, an outgoing rolldate message and a new date message for the next business day. The outgoing rolldate message is transmitted to the asset manager.

The SOB ready message signals the start of the business day by account and region. It is transmitted to the asset custodian, the purpose of the regional SOB ready message is to inform the asset custodian that the daily SOB package has been received and that the asset custodian can resume transmitting trade acknowledgment messages to the asset manager.

When the account level SOB ready message is received by the custody information database, the custody information database ensures that the roll date message has been delivered. Once this is confirmed, the suspended account is released and all outstanding acknowledgment transaction instructions are delivered to the asset manager. Also the message is updated as completed. When the region level SOB ready message is received, the message is updated and marked completed.

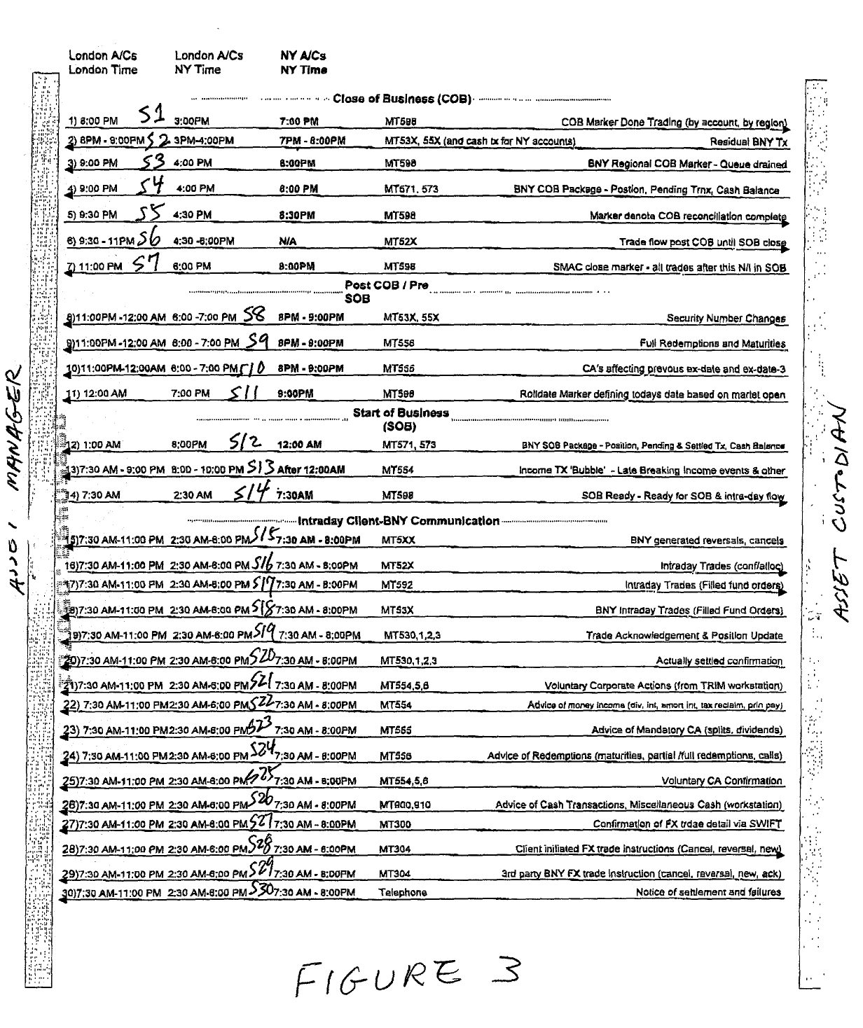

It may be instructive to describe an example of the message flow between an asset manager and an asset custodian in a typical business day cycle. Referring to FIG. 3, there is shown a schematic diagram of message flow of messages exchanged between the asset manager 11 and the asset custodian 21 in an illustrative business day. It should be noted that a business day, for purposes of clarity throughout this disclosure, begins with the close of business of the day before and ends with the close of business day. In step S1, the asset manager transmits a SWIFT MT598 message to the asset custodian to inform the asset custodian of the Close of Business (“COB”) day to mark the end of the business day for the asset manager.

In step S2, the asset custodian transmits a Residual Transaction message in SWIFT MT53X, 55X format. The residual transaction message capital and income or settlement transactions which need to be reconciled between the asset manager and the asset custodian. In step S3, the asset custodian transmits to the asset manager a regional COB message informing the asset manager that the regional trading for the day has terminated and that the queue of trading transactions to be processed by the asset custodian has been completed. In a preferred embodiment, the regional and account COB message informing the asset manager is transmitted automatically by the asset custodian. In an alternative embodiment, the regional and account COB message is transmitted manually by an operator to signify that the transactions have been completed.

In step S4, the asset custodian transmits to the asset manager a COB package detailing the positions of different securities for the account (fund or plan) and the settled transactions, pending transactions yet to be settled, and the cash balance remaining on the account. The COB package is a combination of SWIFT MT571 and MT573 messages detailing a statement of holdings for the fund and any pending transactions which have yet to be reconciled and any settled transactions between the asset manager and the asset custodian.

In step S5, the asset manager transmits to the asset custodian a COB reconciliation complete message to denote that the reconciliation between the asset manager and the asset custodian is complete. In an alternative embodiment, the custody information database is replicated and transmitted to the asset manager for reconcilliation. In step S6, the asset manager transmits to the asset custodian transmits a trade flow post COB until the SOB close message terminating message transmission from the asset manager to the asset custodian. In step S7, the asset custodian transmits to the asset manager a processing systems closed message indicating that processing of transactions has been completed. The processing systems closed message additionally indicates the end of the close of business cycle and the start of any post-COB and pre-SOB transactions.

In step S8, the asset custodian transmits to the asset manager any security number changes for assets held in custody for the asset manager. In step S9, the asset custodian transmits to the asset manager any advice of redemptions and maturities of assets held in custody for the asset manager. In step S10, the asset custodian transmits to the asset manager any advice of income in the form of securities for assets held in custody for the asset manager. In step S11, the asset custodian transmits to the asset manager a rolldate message so that both the asset manager and the asset custodian progress to the next business day. The rolldate message indicates the end of the post-COB and pre-SOB cycle and the start of the next SOB cycle.

In step S12, the asset custodian transmits to the asset manager a SOB package consisting of an up to date record of positions and cash balances pertaining to assets held in custody by the asset custodian. The SOB package additionally includes any pending transactions that have yet to be reconciled between the asset manager and the asset custodian. In step S13, the asset custodian transmits to the asset manager advice of money income corresponding to the assets held in custody. In step S14, the asset manager transmits to the asset custodian a SOB ready message indicating that the asset manager is ready for the start of the business day cycle.

The following steps illustrate conventional messages transmitted between the asset manager and the asset custodian intraday. In step S15, the asset custodian transmits to the asset manager any asset custodian generated reversals and cancels on the transactions of the prior business day. In step S16, the asset manager transmits to the asset custodian any new intraday trades. In step S17, the asset manager transmits to the asset custodian any cancellations of any intraday trades via an MT592 message. In step S18, the asset custodian transmits to the asset manager confirmation of any of the intraday trades. In step S19, the asset custodian transmits to the asset manager trade acknowledgments and position updates that correspond to pending intraday trades. In step S20, the asset custodian transmits to the asset manager confirmations of intraday trades. In step S21, the asset custodian transmits to the asset manager voluntary corporate actions such as cash or stock dividends corresponding to the assets. In step S22, the asset custodian transmits to the asset manager advice of money income such as dividends, interest, and principal payments. In step S23, the asset custodian transmits to the asset manager any advice of mandatory corporate actions. such as stock splits. In step S24, the asset custodian transmits to the asset manager advice of redemptions such as maturities and partial and full redemptions for the assets held in custody. In step S25, the asset custodian transmits to the asset manager a confirmation of voluntary corporate actions. In step S26, the asset custodian transmits to the asset manager any advice of cash transactions. In step S27, the asset custodian transmits to the asset manager any confirmation of foreign exchange trade details. In step S28, the asset manager transmits to the asset custodian any client initiated foreign exchange trade instructions/ In step S29, the asset custodian transmits to the asset manager any third party foreign exchange trade instructions. Optionally, in step S30, any failures in the settlement process is noted by a telephonic call between the parties to note any failures in the settlement process.

The method and system described above defines a business day as close of business to close of business. Therefore, the a business day will be different in one region to another. And the processing frames from one region's day will overlap or come at a different time from the next region's day. The methodology across multiple regions enables asset managers and asset custodians in different regions to measure their systematic performance against benchmarks and to minimize the manual intervention needed.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention and is not intended to illustrate all possible forms thereof. It is also understood that the words used are words of description, rather than limitation, and that details of the structure may be varied substantially without departing from the spirit of the invention and the exclusive use of all modifications which come within the scope of the appended claims is reserved.

What is claimed is:

1. A messaging interface system between an asset manager and an asset custodian, said asset manager and said asset custodian capable of transmitting and receiving messages over a data network for communicating said messages thereover during a defined business day cycle over regions having differing business day cycles, said system comprising:
an asset manager interface coupled to said asset manager and said data network, said asset manager interface for generating and transmitting event-specific messages; and
an asset custodian interface coupled to said asset custodian and said data network, said asset custodian interface for receiving said event-specific messages, said asset custodian interface initiating automated processes upon receipt of said event-specific messages.

2. The messaging interface system of claim 1 wherein said event-specific messages signify the close of business of said asset manager.

3. The message interface system of claim 2 wherein said event-specific messages signify account close of business of said asset manager.

4. The message interface system of claim 2 wherein said event-specific messages signify regional close of business of said asset manager.

5. The message interface system of claim 1 wherein said event-specific messages signify closed processing of said asset custodian.

6. The message interface system of claim 5 wherein said event-specific messages signify regional closed processing of said asset custodian.

7. The message interface system of claim 1 wherein said event-specific messages signify rolldate.

8. The message interface system of claim 1 wherein said event-specific messages signify start of business ready.

9. The message interface system of claim 1 wherein said event-specific messages are SWIFT formatted.

10. The message interface system of claim 1 further comprising:
a custody information database coupled to said asset custodian.

11. The message interface system of claim 10 wherein said custody information database suspends records in the database corresponding to a close of business message.

12. A system for transmitting and receiving electronic messages for trading securities among an asset manager and an asset custodian, said asset manager having one or more defined business day cycles, said asset custodian synchronizing to said one or more defined business day cycles, said system comprising:
a database for storing custody information concerning said securities; and
an interface coupled to said database for transmitting event-specific messages upon occurrence of predetermined events during said business day cycle.

13. The system of claim 12 wherein said database is a relational database.

14. The system of claim 12 wherein said event-specific messages are SWIFT formatted.

15. The system of claim 12 wherein said event-specific messages signify the close of business of said asset manager.

16. The system of claim 15 wherein said event-specific messages signify account close of business of said asset manager.

17. The system of claim 15 wherein said event-specific messages signify regional close of business of said asset manager.

18. The system of claim 12 wherein said event-specific messages signify closed processing of said asset custodian.

19. The system of claim 18 wherein said event-specific messages signify regional closed processing of said asset custodian.

20. The system of claim 12 wherein said event-specific messages signify rolldate.

21. The message interface system of claim 12 wherein said event-specific messages signify start of business ready.
